(19) United States
(12) Patent Application Publication
(10) Pub. No.: US 2011/0294911 A1
(43) Pub. Date: Dec. 1, 2011

(54) POLYURETHANE SURFACTANT STABILIZED POLYURETHANE FOAMS

(75) Inventors: Jan Schöberger, Haan (DE); Sebastian Dörr, Dusseldorf (DE)

(73) Assignee: Bayer MaterialScience AG, Leverkusen (DE)

(21) Appl. No.: 13/144,746

(22) PCT Filed: Jan. 13, 2010
(86) PCT No.: PCT/EP2010/000120

§ 371 Date: Jul. 15, 2011

(30) Foreign Application Priority Data
Jan. 24, 2009 (EP) 09000993.7

(51) Int. Cl. C08J 9/30; C08L 75/04; C08K 3/20

(52) U.S. Cl. 521/70; 524/500; 525/458; 521/137

(57) ABSTRACT

The invention relates to the production of hydrophilized polyurethane foams, especially for wound treatment, wherein a composition containing a polymer and special polyurethane-based stabilizers is expanded and dried.

The invention relates to the production of hydrophilicized polyurethane foams, particularly for wound management, wherein a composition containing a polymer and specific polyurethane-based stabilizers is frothed and dried.

The use of wound contact materials made of foams for treating weeping wounds is prior art. Owing to their high absorbency and their good mechanical properties, polyurethane foams produced by reaction of mixtures of diisocyanates and polyols or NCO-functional polyurethane prepolymers with water in the presence of certain catalysts and also (foam) additives are generally used. Aromatic diisocyanates are generally employed, since they are best foamable. Numerous forms of these processes are known, for example described in U.S. Pat. No. 3,978,266, U.S. Pat. No. 3,975,567 and EP-A 0 059 048. However, the aforementioned processes have the disadvantage that they require the use of reactive mixtures, containing diisocyanates or corresponding NCO-functional prepolymers, whose handling is technically inconvenient and costly, since appropriate protective measures are necessary for example.

One alternative to the above-described process, in which diisocyanates or NCO-functional polyurethane prepolymers are utilized, is a process based on polyurethane dispersions (which are essentially free of isocyanate groups) into which air or other gases are incorporated by vigorous stirring in the presence of suitable (foam) additives. So-called mechanical polyurethane foams are obtained after drying and curing. In connection with wound contact materials, such foams are described in EP-A 0 235 949 and EP-A 0 246 723, the foam either having a self-adherent polymer added to it, or being applied to a film of a self-adherent polymer. U.S. Pat. No. 4,655,210 describes the use of the aforementioned mechanical foams for wound dressings having a specific construction made up of backing, foam and skin contact layer. As described in EP-A 0 235 949, EP-A 0 246 723 and U.S. Pat. No. 4,655,210, foams were always produced from the polyurethane dispersions using additive mixtures containing ammonium stearate. This is an immense disadvantage, since ammonium stearate, in the amounts customarily used, leads to highly cytotoxic foams. This is unacceptable for wound contact foams in particular. In addition, ammonium stearate is thermally decomposable, and the ammonia formed has to be removed, which is technically inconvenient. On the other hand, ammonium stearate cannot simply be replaced by other stearates or completely different (foam) additives, since they fail to give a comparatively good foam structure, characterized by very fine pores in particular.

An alternative stabilization of PU foams by means of alkylpolyglycosides is described in WO 2008/031520. These additives likewise give rise to a highly cytotoxic effect, however, and markedly worsen the porosity of the foams obtained. Moreover, these foam additives cause undesirable yellowing of the foams, which is possibly attributable to these glycosides being metabolized by microorganisms.

EP 0731148 describes hydrophilic-modified branched polyisocyanate adducts based on polyisocyanates having an average NCO functionality of at least 2.5, which are reacted with hydrophilic polyethers. These components have the disadvantage that the relatively high degree of branching prevents optimal actualization of the hydrophilic potential of the polyether chain, since steric reasons make it impossible for more than 2 polyether chains to be fully in the aqueous phase at the same time when the hydrophobic moiety of the adduct is at the same time localized at a hydrophobic phase. As a result, part of the hydrophilic moiety of the dispersing auxiliaries described in EP 0731148 will always be close to the hydrophobic phase.

The present invention therefore has for its object to provide suitable surfactants as (foam) additives which can be frothed in combination with polymers or polymer mixtures, particularly with polyurethanes, especially with aqueous polyurethane dispersions, and, after drying, provide finely pored foams which are homogeneous even when very thick and which are not cytotoxic and are very substantially free of (thermally) detachable components such as amines.

It has now been found that this object is achieved when novel surfactants, based on polyurethanes, are used as an additive.

The present invention accordingly provides a process for producing polymeric foams wherein a composition which likewise forms part of the subject matter of the present invention and is obtainable by mixing at least polyurethanes (I) having a free isocyanate group content of not more than 1.0% by weight and a 10% to 95% by weight content of ethylene oxide units (molecular weight=44 g/mol) incorporated via monofunctional alcohols B) and arranged within polyether chains, which have been prepared by reaction of
A) polyisocyanate prepolymers having an (average) NCO functionality of not less than 1, preferably in the range from 1.7 to 2.5, more preferably in the range from 1.8 to 2.2 and most preferably 2 with
B) 10 to 100 equivalent %, based on the isocyanate groups of A), of a monohydric alcohol component comprising at least one monohydric polyether alcohol having a number average molecular weight in the range from 150 to 5000 g/mol and an oxyethylene units content of 30 to 100 mol %, based on the total content of oxyalkylene units in the monohydric polyether alcohol,
C) 0 to 20 equivalent %, based on the isocyanate groups of A), of a monohydric alcohol component comprising monohydric alcohols having a number average molecular weight in the range from 32 to 5000 g/mol which are other than the compounds of component B),
D) 0 to 80 equivalent %, based on the isocyanate groups of A), of constructional components having a number average molecular weight in the range from 32 to 10 000 g/mol which are at least difunctional for the purposes of the NCO addition reaction
with urethane formation and with or without urea formation, wherein any excess NCO groups have been reacted away, by simultaneous or subsequent secondary reactions, down to a residual content of not more than 1.0% by weight,
   and foamable polymers (II), is frothed and dried.

The content of ethylene oxide units (molecular weight=47 g/mol) in the polyurethanes which are essential to the present invention is preferably in the range from 20% to 75% by weight, more preferably in the range from 35% to 60% by weight and most preferably in the range from 45% to 55% by weight. The content of free isocyanate groups in the polyurethanes which are essential to the present invention is below 1% by weight; and, in general, free isocyanate groups are no longer detectable.

Suitable polyisocyanate prepolymers for component A) are the well-known aliphatic, aromatic or cycloaliphatic isocyanate-functional prepolymers having the aforementioned NCO functionalities.

The isocyanate-functional prepolymers useable in A) are obtainable by reaction of polyisocyanates with hydroxyl-functional polyols in the presence or absence of catalysts and also in the presence or absence of auxiliary and adjunct materials.

Examples of such suitable isocyanate-functional building blocks A) are prepolymers based on polyols and low molecular weight isocyanate building blocks. Low molecular weight isocyanate building blocks are compounds such as 1,4-butylene diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 4-isocyanatomethyl-1,8-octane diisocyanate (nonane triisocyanate), 1,4-phenylene diisocyanate, 2,4- and/or 2,6-tolylene diisocyanate, 1,5-naphthylene diisocyanate, 2,2′- and/or 2,4′- and/or 4,4′-diphenylmethane diisocyanate, 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1-C8-alkyl groups.

The isocyanate-functional components A) may contain for example uretdione, isocyanurate, urethane, urea, allophanate, biuret, iminooxadiazinedione or oxadiazinetrione structures and also mixtures thereof.

The polymeric polyols for preparing A) are the well-known polyurethane coating technology polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols. These can be used for preparing the prepolymer A) individually or in any desired mixtures with each or one another.

Suitable polyester polyols are the well-known polycondensates formed from di- and also optionally tri- and tetraols and di- and also optionally tri- and tetracarboxylic acids or hydroxy carboxylic acids or lactones. Instead of the free polycarboxylic acids it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentyl glycol or neopentyl glycol hydroxypivalate, of which 1,6-hexanediol and isomers, 1,4-butanediol, neopentyl glycol and neopentyl glycol hydroxypivalate are preferred. Besides these it is also possible to use polyols such as trimethylolpropane, glycerol, erythritol, pentaerythritol, trimethylolbenzene or trishydroxyethyl isocyanurate.

Useful dicarboxylic acids include phthalic acid, isophthalic acid, terephthalic acid, tetra-hydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethyl glutaric acid and/or 2,2-dimethylsuccinic acid. The corresponding anhydrides can also be used as a source of an acid.

When the average functionality of the polyol to be esterified is greater than 2, monocarboxylic acids, such as benzoic acid and hexanecarboxylic acid can be used as well in addition.

Preferred acids are aliphatic or aromatic acids of the aforementioned kind. Adipic acid, isophthalic acid and phthalic acid are particularly preferred.

Hydroxy carboxylic acids useful as reaction participants in the preparation of a polyester polyol having terminal hydroxyl groups include for example hydroxycaproic acid, hydroxybutyric acid, hydroxydecanoic acid, hydroxystearic acid and the like. Suitable lactones include caprolactone, butyrolactone and homologues. Caprolactone is preferred.

Low molecular weight polyols can also be used for preparing A). Examples of such polyols are ethylene glycol, 1,2-propanediol, 1,3-propanediol, 1,3-butanediol, 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned kind.

The use of polyether polyols for preparing A) is preferred.

The polyether polyols for preparing component A) generally have number average molecular weights Mn in the range from 300 to 8000 g/mol, preferably in the range from 400 to 6000 g/mol and more preferably in the range from 600 to 3000 g/mol.

It is further particularly preferable for them to have an unsaturated end group content of not more than 0.02 milliequivalents per gram of polyol (meq/g), preferably not more than 0.015 meq/g and more preferably not more than 0.01 meq/g (method of determination: ASTM D2849-69).

The polyols used for preparing the compounds of component A) preferably have an OH functionality in the range from 1.5 to 4, more preferably in the range from 1.8 to 2.5 and most preferably in the range from 1.9 to 2.1.

It is particularly preferable for them to have a particularly narrow molecular weight distribution, i.e. a polydispersity (PD=Mw/Mn) in the range from 1.0 to 1.5, and/or an OH functionality of greater than 1.9. The polyether polyols mentioned preferably have a polydispersity in the range from 1.0 to 1.5 and an OH functionality of greater than 1.9 and more preferably of not less than 1.95.

Such polyether polyols are obtainable in a conventional manner by alkoxylation of suitable starter molecules, particularly under double metal cyanide (DMC) catalysis. This is described for example in US-A 5158 922 (Example 30 for instance) and EP-A 0 654 302 (page 5 line 26 to page 6 line 32).

Suitable starter molecules for preparing the polyether polyols are, for example, simple, low molecular weight polyols, water, organic polyamines having at least two N—H bonds or any desired mixtures thereof. Suitably alkylene oxides for the alkoxylation are, in particular, ethylene oxide and/or propylene oxide, which can be used in any desired order or else in admixture in the alkoxylation reaction.

Preferred starter molecules for preparing the polyether polyols by alkoxylation, particularly by following the DMC method, are, in particular, simple polyols such as ethylene glycol, diethylene glycol, triethylene glycol, butyl diglycol, 1,3-butylene glycol, 1,3-propylene glycol, 1,2-propanediol, 1,3-propanediol, 1,4-butanediol, 1,6-hexanediol, cyclohexanediol, 1,4-cyclohexane-dimethanol, neopentyl glycol, 2-ethyl-1,3-hexanediol, glycerol, trimethylolethane, trimethylolpropane, pentaerythritol, sorbitol, triethanolamine, hydroquinone dihydroxyethyl ether, bisphenol A (2,2-bis(4-hydroxyphenyl)propane), hydrogenated bisphenol A (2,2-bis(4-hydroxy-cyclohexyl)propane) and also low molecular weight hydroxyl-containing esters of such polyols with dicarboxylic acids of the kind exemplified hereinbelow or low molecular weight ethoxylation or propoxylation products of such simple polyols, or any desired mixtures of such modified or unmodified alcohols.

Useful polyether polyols include for example the well-known polyurethane chemistry polytetra-methylene glycol polyethers obtainable by polymerization of tetrahydrofuran by means of cationic ring opening, and also polypropylene glycol and polycarbonate polyols, or mixtures thereof, with particular preference being given to polypropylene glycol.

Useful polyether polyols likewise include the well-known addition products of styrene oxide, ethylene oxide, propylene oxide, butylene oxide and/or epichlorohydrin onto di- or polyfunctional starter molecules.

Also suitable are ester diols of the specified molecular weight range such as α-hydroxybutyl-ε-hydroxycaproic acid ester, ω-hydroxyhexyl-γ-hydroxybutyric acid ester, β-hydroxyethyl adipate or bis(β-hydroxyethyl) terephthalate.

Monofunctional isocyanate-reactive hydroxyl-containing compounds may also be used. Examples of such monofunctional compounds are ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol.

It is further possible to use NH₂- and/or NH-functional components for preparing the isocyanate prepolymers.

Suitable components for chain extension are organic di- or polyamines such as, for example, ethylenediamine, 1,2- and 1,3-diaminopropane, 1,4-diaminobutane, 1,6-diaminohexane, isophoronediamine, isomer mixtures of 2,2,4- and 2,4,4-trimethylhexamethylenediamine, 2-methylpentamethylenediamine, diethylenetriamine, diaminodicyclohexylmethane and/or dimethylethylenediamine.

It is further possible to use compounds which as well as a primary amino group also have secondary amino groups or which as well as an amino group (primary or secondary) also have OH groups. Examples thereof are primary/secondary amines, such as diethanolamine, 3-amino-1-methylaminopropane, 3-amino-1-ethylaminopropane, 3-amino-1-cyclohexyl aminopropane, 3-amino-1-methylaminobutane, alkanolamines such as N-aminoethylethanolamine, ethanolamine, 3-aminopropanol, neopentanolamine, which are used for chain extension or termination. Chain termination typically utilizes amines having one isocyanate-reactive group such as methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amide-amines formed from diprimary amines and monocarboxylic acids, monoketime of diprimary amines, primary/tertiary amines, such as N,N-dimethylaminopropylamine.

The compounds of component A) are preferably prepolymers of the aforementioned kind having exclusively aliphatically or cycloaliphatically attached isocyanate groups or mixtures thereof and an average NCO functionality in the range from 1.7 to 2.5, preferably 1.8 to 2.2 more preferably 2, for the mixture.

It is particularly preferable for A) to utilize polyisocyanate prepolymers of the aforementioned kind which are based on hexamethylene diisocyanate, isophorone diisocyanate or the isomeric bis(4,4′-isocyanatocyclohexyl)methanes, and also mixtures of the aforementioned diisocyanates.

The isocyanate-functional prepolymers A) are prepared by reacting the low molecular weight polyisocyanates with the polyols at an NCO/OH ratio of preferably 2:1 to 20:1. The reaction temperature is generally in the range from 20 to 160° C. and preferably in the range from 60 to 100° C. A particularly preferred embodiment comprises subsequently removing the fraction of unconverted polyisocyanates by means of suitable methods. Thin-film distillation is customarily used for this purpose because it yields products having low residual monomer contents of less than 5% by weight, preferably less than 0.5% by weight and most preferably less than 0.1% by weight.

Suitable nonionically hydrophilicizing compounds of component B) are monofunctional polyoxyalkylene ethers which contain at least one hydroxyl group. Examples are the monohydroxyl-functional polyalkylene oxide polyether alcohols containing on average 5 to 70 and preferably 7 to 55 ethylene oxide units per molecule and obtainable in a conventional manner by alkoxylation of suitable starter molecules (for example in Ullmanns Encyclopädie der technischen Chemie, 4th edition, volume 19, Verlag Chemie, Weinheim pages 31-38). These are either pure polyethylene oxide ethers or mixed polyalkylene oxide ethers, containing at least 30 mol % of ethylene oxide units, based on all alkylene oxide units present.

Particularly preferred nonionic compounds are monofunctional mixed polyalkylene oxide polyethers having 30 to 100 mol % of ethylene oxide units and 0 to 70 mol % of propylene oxide units based on the total amount of oxyalkylene units.

Useful starter molecules for such building blocks include saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methylcyclo-hexylamine, N-ethylcyclohexylamine or dicyclohexylamine and also heterocyclic secondary amines such as morpholine, pyrrolidine, piperidine or 1H pyrazole. Preferred starter molecules are saturated monoalcohols of the aforementioned kind. Particular preference is given to using diethylene glycol monobutyl ether or n-butanol as starter molecules.

Useful alkylene oxides for the alkoxylation reaction are in particular ethylene oxide and propylene oxide, which can be used in any desired order or else in admixture in the alkoxylation reaction.

Suitable building blocks of component C) are monohydric alcohol components consisting of at least one monohydric alcohol of the number average molecular weight range 32 to 5000 g/mol, which is other than the alcohols of component B). Examples are methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, fatty alcohols, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or oleyl alcohol, araliphatic alcohols such as benzyl alcohol, anisyl alcohol or cinnamyl alcohol.

Monofunctional polymers are also usable, examples being polyoxyalkylene ethers which contain a hydroxyl group, and less than 30 mol % of ethylene oxide. Preference is given to monofunctional polypropylene oxide polyethers with no ethylene oxide building blocks whatsoever.

Suitable building blocks of component D) are isocyanate-reactive components of the number average molecular weight range 32 to 10 000 g/mol which are polyfunctional for the purposes of the NCO addition reaction. Examples of low molecular weight polyols in particular, preferably with up to 20 carbon atoms, are ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxy-cyclohexyl)propane), trimethylolpropane, glycerol, pentaerythritol and also any desired mixture thereof with each or one another. It is also possible to use polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols having a number average molecular weight of up to 10 000 g/mol. It is also possible to use particularly di- or polyamines such as 1,2-ethylene diamine, 1,2- and 1,3-diaminopropane, 1,4-diaminobutane, 1,6-diaminohexane, isophoronediamine, isomer mixtures of 2,2,4- and 2,4,4-trimethylhexamethylene diamine, 2-methylpentamethylenediamine, diethylenetriamine, triaminononane, 1,3- and 1,4-xylylenediamine, α,α,α′,α′-tetramethyl-1,3- and -1,4-xylylenediamine and 4,4-diaminodicyclohexylmethane and/or dimethylethylenediamine. It is likewise possible to use hydrazine and also hydrazides such as adipodihydrazide. Preference is given to isophoronediamine, 1,2-ethylenediamine, 1,4-diaminobutane and diethylenetriamine. The component D) can further utilize compounds which as well as a primary amino group also have secondary amino groups or which as well as an amino group (primary or secondary) also have OH groups. Examples thereof are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine. Mixtures of the components mentioned are also usable as building block D).

One preferred version does not utilize component D), another preferred version utilizes at least one polyoxyalkylene ether as component D). A very particularly preferred version utilizes as component D) a polyoxyalkylene ether which contains at least two isocyanate-reactive groups such as hydroxyl groups and additionally at least 30 mol % of ethylene oxide units, based on all alkylene oxide units present. Particular preference for use as D) is given to difunctional polyalkylene oxide polyethers which include 30 to 100 mol % of ethylene oxide units and 0 to 70 mol % of propylene oxide units, and it is even more preferable for 70 to 100 mol % of ethylene oxide units and 0 to 30 mol % of propylene oxide units to be present. It is most preferable for ethylene oxide only to be present in D) as alkylene oxide units. Such polyoxyalkylene ethers are obtainable in a conventional manner by alkoxylation of suitable, at least difunctional starter molecules.

One preferred version of preparing the polyurethanes of the present invention comprises first preparing the isocyanate-functional prepolymer A) by reacting a diisocyanate of the aforementioned kind with a deficiency of a hydrophobic diol such as, for example, polypropylene glycol having a number average molecular weight of 2000 g/mol for example. The molar ratio between isocyanate groups and isocyanate-reactive groups in this reaction is preferably in the range from 2:1 to 20:1 and more preferably in the range from 5:1 to 15:1. After reaction of the isocyanate-reactive groups, a preferred version comprises removing at least a large portion of the remaining diisocyanate by distillation, for example by a thin-film evaporator and heating in vacuo. The mixture obtained in the process is subsequently reacted with component B) and optionally component C) and/or optionally with component D). Preference for use as component B) is then given to a monohydric polyether alcohol of the number average molecular weight range 350 to 3000 g/mol, more preferably 700 to 2300 g/mol, which preferably has an ethylene oxide unit content of 70% to 100% by weight, based on the total content of oxyalkylene units.

The molar ratio between isocyanate groups and isocyanate-reactive groups in the reaction of A) with B) and optionally C) and/or D) is preferably in the range from 0.5:1 to 2:1, more preferably in the range from 0.7:1 to 1.2:1 and most preferably equal to 1:1. Preferred temperature range for the reaction is 20 to 180° C. and more preferably 40 to 130° C. The reaction is preferably carried on until no isocyanate groups whatsoever are detectable by IR spectroscopy. One particularly preferred version utilizes neither C) nor D), another particularly preferred version utilizes D) only.

The use of catalysts known to a person skilled in the art is possible both in the preparation of prepolymers A) and in the preparation of the polyurethanes of the present invention. Tertiary amines, tin, zinc or bismuth compounds such as triethylamine, 1,4-diazabicyclo-[2,2,2]-octane, tin dioctoate, dibutyltin dilaurate and zinc dioctoate can be added for example. Stabilizers such as benzoyl chloride, isophthaloyl chloride, dibutyl phosphate, 3-chloropropionic acid, antioxidants or methyl tosylate may be added during and/or after the preparation, if desired.

The polyurethanes of the present invention are preferably prepared using the components A) to D) in the following quantitative ranges:

10% to 80% by weight and more preferably 20% to 50% by weight for component A),

20% to 90% by weight and more preferably 30% to 50% by weight for component B),

0% to 15% by weight and more preferably 0% to 5% by weight for component C), and

0% to 60% by weight and more preferably 10% to 30% by weight for component D).

In addition to the components A), B), C) and D) mentioned, still further isocyanate building blocks and isocyanate-reactive building blocks which do not come within A), B), C) or D) may be incorporated in the polyurethanes of the present invention, but preferably at less than 20% by weight, and most preferably no building blocks other than A), B), C) and D) are present.

The polymers (II) used are based for example on polystyrenes, polyvinyl chlorides, polyacrylates, polycarbonimides, polymethacrylimides, polyamides, phenolic and urea resins, polysiloxanes, polyaminoamines, poly(hydroxy carboxylic acid)s, polycarbonates, polyesters, polyester polyamides, polyester polyacrylates, polyester polycarbonates, polyoxyalkylene ethers, polyether polyacrylates, polyether polycarbonates, polyether polyamides, polyethylene polyimines, polyureas, polyurethanes, polyurethane polyacrylates, polyurethane polyesters, polyurethane polyethers, polyurethane polyureas and polyurethane polycarbonates and also any desired polymer mixtures. Preference is given to using polyureas, polyurethanes, polyurethane polyacrylates, polyurethane polyesters, polyurethane polyethers, polyurethane polyureas and polyurethane polycarbonates and also any desired polymer mixtures thereof, more preferably in the form of their aqueous dispersions.

Such preferred aqueous dispersions are anionically hydrophilicized polyurethane dispersions (II), which are obtainable by

E) isocyanate-functional prepolymers being produced from at least
E1) organic polyisocyanates
E2) polymeric polyols having number average molecular weights in the range from 400 to 8000 g/mol and OH functionalities in the range from 1.5 to 6 and
E3) optionally hydroxyl-functional compounds having molecular weights in the range from 62 to 399 g/mol and
E4) optionally isocyanate-reactive, anionic or potentially anionic and/or optionally non-ionic hydrophilicizing agents,

F) their free NCO groups then being wholly or partly reacted
F1) optionally with amino-functional compounds having molecular weights in the range from 32 to 400 g/mol and/or
F2) with isocyanate-reactive, preferably amino-functional, anionic or potentially anionic hydrophilicizing agents
   by chain extension, and the prepolymers being dispersed in water before, during or after step F), any potentially ionic groups present being converted into the ionic form by partial or complete reaction with a neutralizing agent.

Significantly, the compounds of components E1) to E4) have no primary or secondary amino groups.

To achieve anionic hydrophilicization, E4) and/or F2) shall utilize hydrophilicizing agents that have at least one NCO-reactive group such as amino, hydroxyl or thiol groups and additionally have —COO⁻ or —SO₃⁻ or —PO₃²⁻ as anionic groups or their wholly or partly protonated acid forms as potentially anionic groups.

Preferred aqueous, anionic polyurethane dispersions (II) have a low degree of hydrophilic anionic groups, preferably from 0.1 to 15 milliequivalents per 100 g of solid resin.

To achieve good sedimentation stability, the number average particle size of the specific polyurethane dispersions is preferably less than 750 mm and more preferably less than 550 nm, determined by laser correlation spectroscopy.

The ratio of NCO groups of compounds of component E1) to NCO-reactive groups such as amino, hydroxyl or thiol groups of compounds of components E2) to E4) is in the range from 1.05 to 3.5, preferably in the range from 1.2 to 3.0 and more preferably in the range from 1.3 to 2.5 to prepare the NCO-functional prepolymer.

The amino-functional compounds in stage F) are used in such an amount that the equivalent ratio of isocyanate-reactive amino groups of these compounds to the free isocyanate groups of the prepolymer is in the range from 40 to 150%, preferably between 50 to 125% and more preferably between 60 to 120%.

Suitable polyisocyanates for component E1) include the well-known aromatic, araliphatic, aliphatic or cycloaliphatic polyisocyanates of an NCO functionality of and correspond to those of component A).

As well as the aforementioned polyisocyanates, it is also possible to use, proportionally, modified diisocyanates or triisocyanates of uretdione, isocyanurate, urethane, allophanate, biuret, iminooxadiazinedione and/or oxadiazinetrione structure.

Preferably, the polyisocyanates or polyisocyanate mixtures of the aforementioned kind have exclusively aliphatically and/or cycloaliphatically attached isocyanate groups and an average NCO functionality in the range from 2 to 4, preferably in the range from 2 to 2.6 and more preferably in the range from 2 to 2.4 for the mixture.

It is particularly preferable for E1) to utilize 1,6-hexamethylene diisocyanate, isophorone diisocyanate, the isomeric bis(4,4′-isocyanatocyclohexyl)methanes, and also mixtures thereof.

E2) utilizes polymeric polyols having a number average molecular weight Mₙ preferably in the range from 400 to 6000 g/mol and more preferably from 600 to 3000 g/mol. These preferably have an OH functionality in the range from 1.8 to 3, more preferably in the range from 1.9 to 2.1.

Such polymeric polyols are the well-known polyurethane coating technology polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols. These can be used in E2) individually or in any desired mixtures with one another.

Such polyester polyols are the well-known polycondensates formed from di- and also optionally tri- and tetraols and di- and also optionally tri- and tetracarboxylic acids or hydroxy carboxylic acids or lactones. Instead of the free polycarboxylic acids it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, also 1,2-propanediol, 1,3-propanediol, butanediol(1,3), butanediol(1,4), hexanediol(1,6) and isomers, neopentyl glycol or neopentyl glycol hydroxypivalate, of which hexanediol(1,6) and isomers, neopentyl glycol and neopentyl glycol hydroxypivalate are preferred. Besides these it is also possible to use polyols such as trimethylolpropane, glycerol, erythritol, pentaerythritol, trimethylolbenzene or trishydroxyethyl isocyanurate.

Useful dicarboxylic acids include phthalic acid, isophthalic acid, terephthalic acid, tetra-hydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethyl glutaric acid and/or 2,2-dimethylsuccinic acid. The corresponding anhydrides can also be used as a source of an acid.

When the average functionality of the polyol to be esterified is greater than 2, monocarboxylic acids, such as benzoic acid and hexanecarboxylic acid can be used as well in addition.

Preferred acids are aliphatic or aromatic acids of the aforementioned kind. Adipic acid, isophthalic acid and optionally trimellitic acid are particularly preferred.

Hydroxy carboxylic acids useful as reaction participants in the preparation of a polyester polyol having terminal hydroxyl groups include for example hydroxycaproic acid, hydroxybutyric acid, hydroxydecanoic acid, hydroxystearic acid and the like. Suitable lactones include caprolactone, butyrolactone and homologues. Caprolactone is preferred.

E2) may likewise utilize hydroxyl-containing polycarbonates, preferably polycarbonate diols, having number average molecular weights Mₙ in the range from 400 to 8000 g/mol and preferably in the range from 600 to 3000 g/mol. These are obtainable by reaction of carbonic acid derivatives, such as diphenyl carbonate, dimethyl carbonate or phosgene, with polyols, preferably diols.

Examples of such diols are ethylene glycol, 1,2-propanediol, 1,3-propanediol, 1,3-butanediol, 1,4-butanediol, 1,6-hexanediol, 1,8-octanediol, neopentyl glycol, 1,4-bishydroxy-methylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned kind.

The polycarbonate diol preferably contains 40% to 100% by weight of hexanediol, preference being given to 1,6-hexanediol and/or hexanediol derivatives, based on the underlying diols. Such hexanediol derivatives are based on hexanediol and have ester or ether groups as well as terminal OH groups. Such derivatives are obtainable by reaction of hexanediol with excess caprolactone or by etherification of hexanediol with itself to form di- or trihexylene glycol.

In lieu of or in addition to pure polycarbonate diols, polyether-polycarbonate diols can also be used in E2).

Hydroxyl-containing polycarbonates preferably have a linear construction.

E2) may likewise utilize polyether polyols. Useful polyether polyols include for example the well-known polyurethane chemistry polytetramethylene glycol polyethers as are obtainable by polymerization of tetrahydrofuran by means of cationic ring opening.

Useful polyether polyols likewise include the well-known addition products of styrene oxide, ethylene oxide, propylene oxide, butylene oxides and/or epichlorohydrin onto di- or polyfunctional starter molecules.

Useful starter molecules include all prior art compounds, for example water, butyl diglycol, glycerol, diethylene glycol, trimethylolpropane, propylene glycol, sorbitol, ethylenediamine, triethanolamine, 1,4-butanediol. Preferred starter molecules are water, ethylene glycol, propylene glycol, 1,4-butanediol, diethylene glycol and butyl diglycol.

Particularly preferred embodiments of the polyurethane dispersions (II) contain as component E2) a mixture of polycarbonate polyols and polytetramethylene glycol polyols, the proportion of polycarbonate polyols in this mixture being in the range from 20% to 80% by weight and the proportion of polytetramethylene glycol polyols in this mixture being in the range from 80% to 20% by weight. Preference is given to a proportion of 30% to 75% by weight for polytetramethylene glycol polyols and to a proportion of 25% to 70% by weight for polycarbonate polyols. Particular preference is given to a proportion of 35% to 70% by weight for polytetramethylene glycol polyols and to a proportion of 30% to 65% by weight for polycarbonate polyols, each subject to the proviso that the sum total of the weight percentages for the polycarbonate and polytetramethylene glycol polyols is 100% and the proportion of component E2) which is contributed by the sum total of the polycarbonate and polytetramethylene glycol polyether polyols is at least 50% by weight, preferably 60% by weight and more preferably at least 70% by weight.

E3) may utilize polyols of the specified molecular weight range with up to 20 carbon atoms, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A, (2,2-bis(4-hydroxycyclohexyl)propane), trimethylolpropane, glycerol, pentaerythritol and also any desired mixtures thereof with each or one another.

Also suitable are ester diols of the specified molecular weight range such as α-hydroxybutyl-ε-hydroxycaproic acid ester, ω-hydroxyhexyl-γ-hydroxybutyric acid ester, β-hydroxyethyl adipate or bis(β-hydroxyethyl) terephthalate.

E3) may further utilize monofunctional hydroxyl-containing compounds. Examples of such monofunctional compounds are ethanol, n-butanol, ethylene glycol monobutyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol.

Preferred compounds for component E3) are 1,6-hexanediol, 1,4-butanediol, neopentyl glycol and trimethylolpropane.

An anionically or potentially anionically hydrophilicizing compound for component E4) is any compound which has at least one isocyanate-reactive group such as a hydroxyl group and also at least one functionality such as for example —COO⁻M⁺, —SO₃⁻M⁺, —PO(O⁻M⁺)₂ where M⁺ is for example a metal cation, H⁺, NH₄⁺, NHR₃⁺, where R in each occurrence may be C₁-C₁₂-alkyl, C₅-C₆-cycloalkyl and/or C₂-C₄-hydroxyalkyl, which functionality enters on interaction with aqueous media a pH-dependent dissociative equilibrium and thereby can have a negative or neutral charge. Useful anionically or potentially anionically hydrophilicizing compounds include mono- and dihydroxy carboxylic acids, mono- and dihydroxy sulphonic acids and also mono- and dihydroxy phosphonic acids and their salts. Examples of such anionic or potentially anionic hydrophilicizing agents are dimethylolpropionic acid, dimethylolbutyric acid, hydroxypivalic acid, malic acid, citric acid, glycolic acid, lactic acid and the propoxylated adduct formed from 2-butenediol and NaHSO₃ as described in DE-A 2 446 440, page 5-9, formula I-III. Preferred anionic or potentially anionic hydrophilicizing agents for component E4) are those of the aforementioned kind that have carboxylate or carboxyl groups and/or sulphonate groups.

Particularly preferred anionic or potentially anionic hydrophilicizing agents of component E4) are those that contain carboxylate or carboxyl groups as ionic or potentially ionic groups, such as dimethylolpropionic acid, dimethylolbutyric acid and hydroxypivalic acid and salts thereof.

Useful nonionically hydrophilicizing compounds for component E4) include for example polyoxyalkylene ethers which contain at least one hydroxyl or amino group, preferably at least one hydroxyl group.

Examples are the monohydroxyl-functional polyalkylene oxide polyether alcohols containing on average 5 to 70 and preferably 7 to 55 ethylene oxide units per molecule and obtainable in a conventional manner by alkoxylation of suitable starter molecules (for example in Ullmanns Encyclopädie der technischen Chemie, 4th edition, volume 19, Verlag Chemie, Weinheim pages 31-38).

These are either pure polyethylene oxide ethers or mixed polyalkylene oxide ethers, containing at least 30 mol % and preferably at least 40 mol % of ethylene oxide units, based on all alkylene oxide units present.

Particularly preferred nonionic compounds are monofunctional mixed polyalkylene oxide polyethers having 40 to 100 mol % of ethylene oxide units and 0 to 60 mol % of propylene oxide units.

Useful starter molecules for such nonionic hydrophilicizing agents include saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or oleic alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methylcyclo-hexylamine, N-ethylcyclohexylamine or dicyclohexylamine and also heterocyclic secondary amines such as morpholine, pyrrolidine, piperidine or 1H pyrazole. Preferred starter molecules are saturated monoalcohols of the aforementioned kind. Particular preference is given to using diethylene glycol monobutyl ether or n-butanol as starter molecules.

Useful alkylene oxides for the alkoxylation reaction are in particular ethylene oxide and propylene oxide, which can be used in any desired order or else in admixture in the alkoxylation reaction.

Component F1) may utilize di- or polyamines such as 1,2-ethylenediamine, 1,2-diaminopropane, 1,3-diaminopropane, 1,4-diaminobutane, 1,6-diaminohexane, isophoronediamine, isomeric mixture of 2,2,4- and 2,4,4-trimethylhexamethylenediamine, 2-methylpentamethylenediamine, diethylenetriamine, triaminononane, 1,3-xylylenediamine, 1,4-xylylenediamine, α,α,α′,α′-tetramethyl-1,3- and -1,4-xylylenediamine and 4,4-diaminodicyclohexylmethane and/or dimethylethylenediamine. It is also possible but less preferable to use hydrazine and also hydrazides such as adipohydrazide.

Component F1) can further utilize compounds which as well as a primary amino group also have secondary amino groups or which as well as an amino group (primary or secondary) also have OH groups. Examples thereof are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine.

Component F1) can further utilize monofunctional isocyanate-reactive amine compounds, for example methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amide-amines formed from diprimary amines and monocarboxylic acids, monoketimes of diprimary amines, primary/tertiary amines, such as N,N-dimethylaminopropylamine.

Preferred compounds for component F1) are 1,2-ethylenediamine, 1,4-diaminobutane and isophoronediamine.

An anionically or potentially anionically hydrophilicizing compound for component F2) is any compound which has at least one isocyanate-reactive group, preferably an amino group, and also at least one functionality such as for example —COO⁻M⁺, —SO₃⁻M⁺, —PO(O⁻M⁺)₂ where M⁺ is for example a metal cation, H⁺, NH₄⁺, NHR₃⁺, where R in each occurrence may be C₁-C₁₂-alkyl, C₅-C₆-cycloalkyl and/or C₂-C₄-hydroxyalkyl, which functionality enters on interaction with aqueous media a pH-dependent dissociative equilibrium and thereby can have a negative or neutral charge.

Useful anionically or potentially anionically hydrophilicizing compounds are mono- and diamino carboxylic acids, mono- and diamino sulphonic acids and also mono- and diamino phosphonic acids and their salts. Examples of such anionic or potentially anionic hydrophilicizing agents are N-(2-aminoethyl)-β-alanine, 2-(2-aminoethylamino)ethanesulphonic acid, ethylenediaminepropyl-sulphonic acid, ethylenediaminebutylsulphonic acid, 1,2- or 1,3-propylenediamine-β-ethyl-sulphonic acid, glycine, alanine, taurine, lysine, 3,5-diaminobenzoic acid and the addition product of IPDA and acrylic acid (EP-A 0 916 647, Example 1). It is further possible to use cyclohexyl-aminopropanesulphonic acid (CAPS) from WO-A 01/88006 as anionic or potentially anionic hydrophilicizing agent.

Preferred anionic or potentially anionic hydrophilicizing agents for component F2) are those of the aforementioned kind that have carboxylate or carboxyl groups and/or sulphonate groups, such as the salts of N-(2-aminoethyl)-β-alanine, of 2-(2-aminoethylamino)ethanesulphonic acid or of the addition product of IPDA and acrylic acid (EP-A 0 916 647, Example 1).

Mixtures of anionic or potentially anionic hydrophilicizing agents and nonionic hydrophilicizing agents can also be used.

A preferred embodiment for producing the specific polyurethane dispersions utilizes components E1) to E4) and F1) to F2) in the following amounts, the individual amounts always adding up to 100% by weight:

5% to 40% by weight of component E1),

55% to 90% by weight of E2),

0.5% to 20% by weight of the sum total of components E3) and F1)

0.1% to 25% by weight of the sum total of the components E4) and F2), with 0.1% to 5% by weight of anionic or potentially anionic hydrophilicizing agents from E4) and/or F2) being used, based on the total amounts of components E1) to E4) and F1) to F2).

A particularly preferred embodiment for producing the specific polyurethane dispersions utilizes components E1) to E4) and F1) to F2) in the following amounts, the individual amounts always adding up to 100% by weight:

5% to 35% by weight of component E1),

60% to 90% by weight of E2),

0.5% to 15% by weight of the sum total of components E3) and F1)

0.1% to 15% by weight of the sum total of components E4) and F2), with 0.2% to 4% by weight of anionic or potentially anionic hydrophilicizing agents from E4) and/or F2) being used, based on the total amounts of components E1) to E4) and F1) to F2).

A very particularly preferred embodiment for producing the specific polyurethane dispersions utilizes components E1) to E4) and F1) to F2) in the following amounts, the individual amounts always adding up to 100% by weight:

10% to 30% by weight of component E1),

65% to 85% by weight of E2),

0.5% to 14% by weight of the sum total of components E3) and F1)

0.1% to 13.5% by weight of the sum total of components E4) and F2), with 0.5% to 3.0% by weight of anionic or potentially anionic hydrophilicizing agents from E4) and/or F2) being used, based on the total amounts of components E1) to E4) and F1) to F2).

The production of the anionically hydrophilicized polyurethane dispersions (II) can be carried out in one or more stages in homogeneous phase or, in the case of a multistage reaction, partly in disperse phase. After completely or partially conducted polyaddition from E1) to E4) a dispersing, emulsifying or dissolving step is carried out. This is followed if appropriate by a further polyaddition or modification in disperse or dissolved (homogeneous) phase.

Any prior art process can be used, examples being the prepolymer mixing process, the acetone process or the melt dispersing process. The acetone process is preferred.

Production by the acetone process typically involves the constituents E2) to E4) and the polyisocyanate component E1) being wholly or partly introduced as an initial charge to produce an isocyanate-functional polyurethane prepolymer and optionally diluted with a water-miscible but isocyanate-inert solvent and heated to temperatures in the range from 50 to 120° C. The isocyanate addition reaction can be speeded using the catalysts known in polyurethane chemistry.

Useful solvents include the customary aliphatic, keto-functional solvents such as acetone, 2-butanone, which can be added not just at the start of the production process but also later, optionally in portions. Acetone and 2-butanone are preferred.

Other solvents such as xylene, toluene, cyclohexane, butyl acetate, methoxypropyl acetate, N-methylpyrrolidone, N-ethylpyrrolidone, solvents having ether or ester units can additionally be used and wholly or partly distilled off or in the case of N-methylpyrrolidone, N-ethylpyrrolidone remain completely in the dispersion. But preference is given to not using any other solvents apart from the customary aliphatic, keto-functional solvents.

Subsequently, any constituents of E1) to E4) not added at the start of the reaction are added.

In the production of the polyurethane prepolymer from E1) to E4), the amount of substance ratio of isocyanate groups to isocyanate-reactive groups is in the range from 1.05 to 3.5, preferably in the range from 1.2 to 3.0 and more preferably in the range from 1.3 to 2.5.

The reaction of components E1) to E4) to form the prepolymer is effected partially or completely, but preferably completely. Polyurethane prepolymers containing free isocyanate groups are obtained in this way, without a solvent or in solution.

The neutralizing step to effect partial or complete conversion of potentially anionic groups into anionic groups utilizes bases such as tertiary amines, for example trialkylamines having 1 to 12 and preferably 1 to 6 carbon atoms and more preferably 2 to 3 carbon atoms in every alkyl radical or alkali metal bases such as the corresponding hydroxides.

Examples thereof are trimethylamine, triethylamine, methyldiethylamine, tripropylamine, N-methylmorpholine, methyldiisopropylamine, ethyldiisopropylamine and diisopropylethylamine. The alkyl radicals may also bear for example hydroxyl groups, as in the case of the dialkylmonoalkanol-, alkyldialkanol- and trialkanolamines. Useful neutralizing agents further include if appropriate inorganic bases, such as aqueous ammonia solution, sodium hydroxide or potassium hydroxide.

Preference is given to ammonia, triethylamine, triethanolamine, dimethylethanolamine or diisopropylethylamine and also sodium hydroxide and potassium hydroxide, particular preference being given to sodium hydroxide and potassium hydroxide.

The bases are employed in an amount of substance which is 50 and 125 mol % and preferably between 70 and 100 mol % of the amount of substance of the acid groups to be neutralized. Neutralization can also be effected at the same time as the dispersing step, by including the neutralizing agent in the water of dispersion.

Subsequently, in a further process step, if this has not already been done or only to some extent, the prepolymer obtained is dissolved with the aid of aliphatic ketones such as acetone or 2-butanone.

In the chain extension of stage F), NH₂- and/or NH-functional components are reacted, partially or completely, with the still remaining isocyanate groups of the prepolymer. Preferably, the chain extension/termination is carried out before dispersion in water.

Chain termination is typically carried out using amines F1) having an isocyanate-reactive group such as methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropyl amine, morpholine, piperidine or suitable substituted derivatives thereof, amide-amines formed from diprimary amines and monocarboxylic acids, monoketimes of diprimary amines, primary/tertiary amines, such as N,N-dimethylaminopropylamine.

When partial or complete chain extension is carried out using anionic or potentially anionic hydrophilicizing agents conforming to definition F2) with NH₂- or NH groups, chain extension of the prepolymers is preferably carried out before dispersion.

The aminic components F1) and F2) can optionally be used in water- or solvent-diluted form in the process of the present invention, individually or in mixtures, any order of addition being possible in principle.

When water or organic solvent is used as a diluent, the diluent content of the chain-extending component used in F) is preferably in the range from 70% to 95% by weight.

Dispersion is preferably carried out following chain extension. For dispersion, the dissolved and chain-extended polyurethane polymer is either introduced into the dispersing water, if appropriate by substantial shearing, such as vigorous stirring for example, or conversely the dispersing water is stirred into the chain-extended polyurethane polymer solutions. It is preferable to add the water to the dissolved chain-extended polyurethane polymer.

The organic solvent still present in the dispersions after the dispersing step is then typically removed by distillation. Removal during the dispersing step is likewise possible.

The residual level of organic solvents in the polyurethane dispersions (II) is typically less than 1.0% by weight and preferably less than 0.5% by weight, based on the entire dispersion.

The pH of the polyurethane dispersions (II) which are essential to the present invention is typically less than 9.0, preferably less than 8.5, more preferably less than 8.0 and most preferably is in the range from 6.0 to 7.5.

The solids content of the polyurethane dispersions (II) is typically in the range from 40% to 70%, preferably in the range from 50% to 65% and more preferably in the range from 55% to 65% by weight.

As well as additive (I), component (I) may contain further additives to improve foam formation, foam stability or the properties of the resulting polymer foam. Such further additives may in principle include any anionic surfactants, non-ionic surfactants, for example EO-PO block copolymers, and cationic surfactants known per se. Preferably, however, component (I) is used alone.

As well as the polymers (II) and the polyurethanes (I) which are essential to the present invention, further, auxiliary and adjunct materials (III) can also be used.

Examples of such auxiliary and adjunct materials (III) are crosslinkers, thickeners or thixotroping agents, other aqueous binders, antioxidants, light stabilizers, emulsifiers, plasticizers, pigments, fillers and/or flow control agents.

Useful crosslinkers include for example unblocked polyisocyanates, amide- and amine-formaldehyde resins, phenolic resins, aldehydic and ketonic resins, examples being phenol-formaldehyde resins, resols, furan resins, urea resins, carbamic ester resins, triazine resins, melamine resins, benzoguanamine resins, cyanamide resins or aniline resins.

Although the surfactants (I) can thicken the polymers (II) markedly, it is possible to use further, commercially available thickeners, such as, for example, derivatives of dextrin, of starch or of cellulose, examples being cellulose ethers or hydroxyethylcellulose, organic wholly synthetic thickeners based on polyacrylic acids, polyvinylpyrrolidones, poly(meth)acrylic compounds or polyurethanes (associative thickeners) and also inorganic thickeners, such as bentonites or silicas.

Other aqueous binders can be constructed for example of polyester, polyacrylate, polyepoxy or other polyurethane polymers. Similarly, the combination with radiation-curable binders as described for example in EP-A-0 753 531 is also possible. It is further possible to employ other anionic or nonionic dispersions, such as polyvinyl acetate, polyethylene, polystyrene, polybutadiene, polyvinyl chloride, polyacrylate and copolymer dispersions.

The compositions which are essential to the present invention typically contain, based on dry substance, 80 to 99.9 parts by weight of a polymer (II) and 0.1 to 20 parts by weight of surfactant (I). Preferably, the compositions contain, based on dry substance, 85 to 99.5 parts by weight of a polymer (II) and 0.5 to 15 parts by weight of surfactant (I), more preferably 90 to 99 parts by weight of a polymer (II) and 1 to 10 parts by weight of surfactant (I), and most preferably 94 to 99 parts by weight of a polymer (II) and 1 to 6 parts by weight of surfactant (I).

The amounts in which the further additives used as auxiliary and adjunct materials (III) are used in the composition of the present invention are typically in the range from 0 to 10 parts by weight, preferably from 0 to 5 parts by weight and more preferably from 0 to 1.5 parts by weight.

The addition of the surfactants (I) and of the optional further additives to the polymer (II) can take place in any desired order. The aforementioned additives may, if appropriate, be used as a solution or dispersion in a solvent such as water.

In principle, it is also possible to bring about a coagulation of the foam by adding coagulants as part of the auxiliary and adjunct materials. Useful coagulants include in principle all multiply cationically functional compounds.

Frothing in the process of the present invention can be accomplished by shaking or mechanical stirring of the composition or by decompressing a blowing gas.

Mechanical frothing can be effected using any desired mechanical stirring, mixing and dispersing techniques by introducing the energy necessary for frothing. Air is generally introduced, but nitrogen and other gases can also be used for this purpose.

The foam thus obtained is, in the course of frothing or thereafter, applied to a substrate or introduced into a mould and dried.

Application to a substrate can be for example by pouring or blade coating, but other conventional techniques are also possible. Multilayered application with intervening drying steps is also possible in principle.

A satisfactory drying rate for the foams is observed at a temperature as low as 20° C. However, temperatures above 30° C. are preferably used for more rapid drying and fixing of the foams. However, drying temperatures should not exceed 200° C., since undesirable yellowing of the foams can otherwise occur, inter alia. Preference is given to using temperatures of 60° C. to 180° C., more preferably 100° C. to 160° C. Drying in two or more stages is also possible. Drying is generally effected using conventional heating and drying apparatus, for example (circulating air) drying cabinets. Application and drying can each be carried out batchwise or continuously, but an entirely continuous process is preferred.

Drying is generally effected using conventional heating and drying apparatus, such as (circulating air) drying cabinets, hot air or IR radiators. Drying by leading the coated substrate over heated surfaces, for example rolls, is also possible.

Application and drying can each be carried out batchwise or continuously, but an entirely continuous process is preferred.

Useful substrates include in particular papers or films which facilitate simple detachment of the foams before their use as wound contact material, for example, to cover an injured site.

Before drying, the foam densities of the foams are typically in the range from 50 to 800 g/litre, preferably in the range from 100 to 500 g/litre and more preferably in the range from 100 to 250 g/litre (mass of all input materials [in g] based on the foam volume of one litre).

After drying, the foams have a microporous, at least partial open-cell structure comprising intercommunicating cells. The density of the dried foams is typically below 0.4 g/cm³, preferably below 0.35 g/cm³ more preferably 0.01 to 0.3 g/cm³, and most preferably in the range from 0.1 to 0.3 g/cm³.

The DIN EN 13726-1 Part 3.2 physiological saline absorbency is typically in the range from 100 to 1500%, preferably in the range from 300 to 1500% and more preferably in the range from 300 to 1000% for the foams (mass of liquid taken up, based on mass of dry foam). The DIN EN 13726-2 Part 3.2 water vapour transmission rate is typically in the range from 1000 to 8000 g/24 h*m², preferably 1000 to 6000 g/24 h*m² and more preferably in the range from 2000 to 5000 g/24 h*m².

The foams possess good mechanical strength and high elasticity. Typical values are tensile strength greater than 0.2 N/mm² and elongation at break greater than 250%. Preferred values are tensile strength greater than 0.4 N/mm² and elongation at break greater than 350% (determined according to DIN 53504).

After drying, the thickness of the foams is typically in the range from 0.1 mm to 50 mm, preferably in the range from 0.5 mm to 20 mm, more preferably in the range from 1 to 10 mm and most preferably in the range from 1 to 6 mm.

The foams can moreover be adhered, laminated or coated to or with further materials, for example materials based on hydrogels, (semi-)permeable films, coatings, hydrocolloids or other foams.

Owing to their advantageous properties, the polyurethane foams of the present invention are preferably used as wound contact materials or for cosmetic purposes. Wound contact materials comprising polyurethane foams within the meaning of the invention are porous materials, preferably having at least some open-cell content, which consist essentially of polyurethanes and protect wounds against germs and environmental influences in the sense of providing a sterile covering, exhibit a high absorbence of physiological saline or wound fluid, ensure a suitable wound climate through suitable moisture permeability, and possess sufficient mechanical strength.

If appropriate, a sterilizing step can be included in the process of the present invention. It is similarly possible in principle for wound contact materials obtainable by following the process of the present invention to be sterilized after they have been produced. Conventional sterilizing processes are used where sterilization is effected by thermal treatment, by means of chemical entities such as ethylene oxide, or irradiation with gamma rays for example.

It is likewise possible to add, incorporate or coat with antimicrobially or biologically active components which, for example, have a positive effect with regard to wound healing and the avoidance of microbial loads.

Preferred active components of the aforementioned kind are those from the group of the antiseptics, growth factors, protease inhibitors and non-steroidal anti-inflammatories/opiates or else active components such as, for example, thrombin alpha for local blood coagulation.

In one preferred embodiment of the present invention, the active component comprises an antiseptic biguanide and/or its salt, preferably the hydrochloride.

Biguanides are compounds derived from biguanide (C₂H₇N₅), particularly its polymers. Antiseptic biguanides are biguanides that have an antimicrobial effect, i.e. act as bacteriostats or preferably as bactericides. The compounds preferably have a broad effect against many bacteria and can be characterized by a minimal microbicidal concentration (MMC, measured in the suspension test) of at least 0.5 ng/ml, preferably at least 12 or at least 25 μg/ml with regard to E. coli.

A preferred antiseptic biguanide according to this invention is poly(imino[imino-carbonyl]iminopolymethylene), the use of poly(hexamethylene)biguanide (PHMB), also known as polyhexanide, as antiseptic biguanide being particularly preferred.

The term “antiseptic biguanides” according to this invention also comprehends metabolites and/or prodrugs of antiseptic biguanides. Antiseptic biguanides can be present as racemates or pure isoforms.

The foamed articles formed from polyurethane foams and the compositions according to the present invention preferably contain antiseptic biguanide and/or its salt, preferably the hydrochloride, in a concentration of 0.01% to 20% by weight, very advantageously 0.1% to 5% by weight. The biguanide may have any desired molecular weight distribution.

The present invention further provides the polymeric foams, particularly polyurethane foams, obtainable by following the process of the present invention and also their use as a wound contact material and also in the cosmetic sector. The use as a wound contact material is preferred.

### EXAMPLES

Unless indicated otherwise, all percentages are by weight. The contents reported for foam additives are based on aqueous solutions.

Solids contents were determined in accordance with DIN-EN ISO 3251.

NCO contents, unless expressly mentioned otherwise, were determined volumetrically in accordance with DIN-EN ISO 11909.

The determination of the average particle size (the number average is reported) of polyurethane dispersion 1 was carried out using laser correlation spectroscopy (instrument: Malvern Zetasizer 1000, Malvern Inst. Limited).

The polypropylene glycol polyethers used were prepared by DMC catalysis (without base), unless otherwise mentioned.

The molar masses reported are weight average molar masses, unless otherwise mentioned. They were determined by GPC analysis in tetrahydrofuran at a flow rate of 0.6 ml/min Polystyrene standards were used for calibration.

### Substances and Abbreviations Used:

Diaminosulfonate: NH₂—CH₂CH₂—NH—CH₂CH₂—SO₃Na (45% in water)

Desmophen® C2200: polycarbonate polyol, OH number 56 mg KOH/g, number average molecular weight 2000 g/mol (Bayer MaterialScience AG, Leverkusen, Germany)

PolyTHF® 2000: polytetramethylene glycol polyol, OH number 56 mg KOH/g, number average molecular weight 2000 g/mol (BASF AG, Ludwigshafen, Germany)

PolyTHF® 1000: polytetramethylene glycol polyol, OH number 112 mg KOH/g, number average molecular weight 1000 g/mol (BASF AG, Ludwigshafen, Germany)

Polyether LB 25: monofunctional polyether based on ethylene oxide/propylene oxide, number average molecular weight 2250 g/mol, OH number 25 mg KOH/g (Bayer MaterialScience AG, Leverkusen, Germany)

HDI: hexamethylene 1,6-diisocyanate

### Example 1

### Preparation of polyurethane dispersion 1

1077.2 g of PolyTHF® 2000, 409.7 g of PolyTHF® 1000, 830.9 g of Desmophen® C2200 and 48.3 g of LB 25 polyether were heated to 70° C. in a standard stirred apparatus. Then, a mixture of 258.7 g of hexamethylene diisocyanate and 341.9 g of isophorone diisocyanate was added at 70° C. in the course of 5 min and the resulting mixture was stirred at 120° C. until the theoretical NCO value was reached or the actual NCO value had dropped slightly below the theoretical NCO value. The final prepolymer was dissolved with 4840 g of acetone and, in the process, cooled down to 50° C. and subsequently admixed with a solution of 27.4 g of ethylenediamine, 127.1 g of isophoronediamine, 67.3 g of diaminosulphonate and 1200 g of water metered in over 10 min. The mixture was subsequently stirred for 10 min. Then, a dispersion was formed by addition of 654 g of water. This was followed by removal of the solvent by distillation under reduced pressure.

The polyurethane dispersion obtained had the following properties:

Solids content: 59.0%
Particle size (LCS): 487 nm

### pH (23° C.): 7.1

### Inventive Example 2

### Preparation of a Surfactant (I) on the Basis of a Difunctional Isocyanate Prepolymer

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr; there was 1 g of chloropropionic acid in the initially charged flask. The NCO prepolymer obtained had an NCO content of 3.23% and a viscosity of 1650 mPas (25° C.).

A 2 1 four-neck flask was initially charged with 225 g of Polyether LB 25 polyether and 100 g of a difunctional polyethylene glycol polyether having a number average molecular weight of 2000 g/mol with stirring. 260 g of the abovementioned NCO prepolymer were added at 80° C. during 2.5 hours, followed by stirring at 80° C. for 4 hours, until NCO groups were no longer detectable by IR spectroscopy. The surfactant obtained was a solid having a weight average molar mass of 21 346 g/mol.

### Inventive Example 3

### Preparation of a Surfactant (I) on the Basis of a Difunctional Isocyanate Prepolymer

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 1 four-neck flask was initially charged with 600 g of a monofunctional polyethylene glycol polyether (MeOPEG) having a number average molecular weight of 2000 g/mol with stirring. 202 g of the abovementioned NCO prepolymer were added at 70° C. during 0.5 hours, followed by stirring at 80° C. for 4 hours, until NCO groups were no longer detectable by IR spectroscopy. The surfactant obtained was a solid having a weight average molar mass of 7232 g/mol.

### Inventive Example 4

### Preparation of a Surfactant (I) on the Basis of a Difunctional Isocyanate Prepolymer

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 1 four-neck flask was initially charged with 750 g of a monofunctional polyethylene glycol polyether (MeOPEG) having a number average molecular weight of 5000 g/mol with stirring. 101 g of the abovementioned NCO prepolymer were added at 70° C. during 0.5 hours, followed by stirring at 80° C. for 4 hours, until NCO groups were no longer detectable by IR spectroscopy. The surfactant obtained was a solid having a weight average molar mass of 13 849 g/mol.

### Inventive Example 5

### Preparation of a Surfactant (I) on the Basis of a Difunctional Isocyanate Prepolymer

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 1 four-neck flask was initially charged with 675 g of Polyether LB 25 polyether with stirring. 202 g of the abovementioned NCO prepolymer were added at 70° C. during 0.5 hours, followed by stirring at 90° C. for 5 hours, until NCO groups were no longer detectable by IR spectroscopy. The surfactant obtained had a viscosity of 5750 mPas (25° C.) and a weight average molar mass of 9511 g/mol.

### Inventive Example 6

### Preparation of a Surfactant (I) on the Basis of a Difunctional Isocyanate Prepolymer

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 1 four-neck flask was initially charged with 281 g of Polyether LB 25 polyether and 125 g of a difunctional polyethylene glycol polyether having a number average molecular weight of 2000 g/mol with stirring. 167.5 g of the abovementioned NCO prepolymer were added at 80° C. during 2.5 hours, followed by stirring at 80 to 100° C. for 5 hours, until NCO groups were no longer detectable by IR spectroscopy. The surfactant obtained was a solid

### Inventive Example 7

### Preparation of a Surfactant (I) on the Basis of a Difunctional Isocyanate Prepolymer

A 2 1 four-neck flask was initially charged with 337 g of Polyether LB 25 polyether and 150 g of a difunctional polyethylene glycol polyether having a number average molecular weight of 2000 g/mol with stirring. 98.5 g Desmodur E 305 (Desmodur E 305 is a substantially linear NCO prepolymer based on hexamethylene diisocyanate, NCO content about 12.8%) are added at 80° C. during 2.5 hours, followed by stirring at 90 to 110° C. for 5 hours, until NCO groups were no longer detectable by IR spectroscopy. The surfactant obtained was a solid.

### Inventive Example 8

### Preparation of a Surfactant (I) on the Basis of a Difunctional Isocyanate Prepolymer

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2 1 four-neck flask was initially charged with 100 g of a difunctional polyethylene glycol polyether having a number average molecular weight of 2000 g/mol with stirring. 258 g of the abovementioned NCO prepolymer were added at 80° C. during 2.5 hours, followed by stirring at 100° C. for 3 hours. Then, 225 g of Polyether LB 25 polyether were added, followed by stirring at 115° C. for 2.5 hours, until NCO groups were no longer detectable by IR spectroscopy. The surfactant obtained was a very viscous liquid.

### Inventive Example 9

### Preparation of a Surfactant (I) on the Basis of a Difunctional Isocyanate Prepolymer

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2 1 four-neck flask was initially charged with 112.5 g of Polyether LB 25 polyether and 150 g of a difunctional polyethylene glycol polyether having a number average molecular weight of 2000 g/mol with stirring. 257 g of the abovementioned NCO prepolymer were added at 80° C. during 0.5 hours, followed by stirring at 100-115° C. for 4 hours, until NCO groups were no longer detectable by IR spectroscopy. The surfactant obtained was a solid.

### Inventive Example 10

### Preparation of a Surfactant (I) on the Basis of a Difunctional Isocyanate Prepolymer

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2 1 four-neck flask was initially charged with 287 g of Polyether LB 25 polyether and 42.5 g of a difunctional polyethylene glycol polyether having a number average molecular weight of 2000 g/mol with stirring. 220 g of the abovementioned NCO prepolymer were added at 80° C. during 0.5 hours, followed by stirring at 100-120° C. for 5 hours, until NCO groups were no longer detectable by IR spectroscopy. The surfactant obtained was a very high-viscosity liquid.

### Inventive Example 11

### Preparation of a Surfactant (I) on the Basis of a Difunctional Isocyanate Prepolymer

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2 1 four-neck flask was initially charged with 200 g of a monofunctional polyethylene glycol polyether (MeOPEG) having a number average molecular weight of 2000 g/mol and 100 g of a difunctional polyethylene glycol polyether having a number average molecular weight of 2000 g/mol with stirring. 257 g of the abovementioned NCO prepolymer were added at 80° C. during 0.5 hours, followed by stirring at 100-120° C. for 4 hours, until NCO groups were no longer detectable by IR spectroscopy. The surfactant obtained was a solid

### Inventive Example 12

### Preparation of a Surfactant (I) on the Basis of a Difunctional Isocyanate Prepolymer

1300 g of HDI and 0.3 g of dibutyl phosphate were initially charged to a 4 1 four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr; there was 2 g of Ronotec 201 (tocopherol) in the initially charged flask. The NCO prepolymer obtained had an NCO content of 3.27% and a viscosity of 1680 mPas (25° C.).

A 2 1 four-neck flask was initially charged with 225 g of Polyether LB 25 polyether and 100 g of a difunctional polyethylene glycol polyether having a number average molecular weight of 2000 g/mol with stirring. 260 g of the abovementioned NCO prepolymer were added at 70° C. during 2.5 hours, followed by stirring at 70° C. for 5 hours, until NCO groups were no longer detectable by IR spectroscopy. The surfactant obtained was a solid.

### Inventive Example 13

### Preparation of a Surfactant (I) on the Basis of a Difunctional Isocyanate Prepolymer

1300 g of HDI were initially charged to a 4 1 four-neck flask with stirring. 1456 g of a difunctional polypropylene glycol polyethylene glycol polyether having a number average molecular weight of 2000 g/mol and an ethylene oxide units content of 24% by weight were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 1.99% and a viscosity of 1040 mPas (25° C.).

A 2 1 four-neck flask was initially charged with 169 g of Polyether LB 25 polyether and 75.0 g of a difunctional polyethylene glycol polyether having a number average molecular weight of 2000 g/mol with stirring. 284 g of the abovementioned NCO prepolymer were added at 70° C. during 2.5 hours, followed by stirring at up to 110° C. for 5 hours, until NCO groups were no longer detectable by IR spectroscopy. The surfactant obtained was a solid.

### Inventive Example 14

### Preparation of a Surfactant (I) on the Basis of a Difunctional Isocyanate Prepolymer

1400 g of HDI and 0.2 g of isophthaloyl chloride were initially charged to a 4 1 four-neck flask with stirring. 1400 g of a difunctional polypropylene glycol polyether having a number average molecular weight of 2000 g/mol (prepared by KOH-catalyzed polymerization) were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.6% and a viscosity of 1480 mPas (25° C.).

A 2 1 four-neck flask was initially charged with 225 g of Polyether LB 25 polyether and 100 g of a difunctional polyethylene glycol polyether having a number average molecular weight of 2000 g/mol with stirring. 233 g of the abovementioned NCO prepolymer were added at 70° C. during 2.5 hours, followed by stirring at not more than 115° C. for 3 hours, until NCO groups were no longer detectable by IR spectroscopy. The surfactant obtained was a solid.

### Inventive Examples S1-S5

Production of Foams from Polyurethane Dispersion 1 and a Surfactant (I)

As indicated in Table 1, 120 g, for each example, of polyurethane dispersion 1, prepared according to Example 1, were mixed with various (foam) additives and frothed by means of a commercially available hand stirrer (stirrer made of bent wire) to a 0.5 litre foam volume. Thereafter, the foams were drawn down on non-stick paper by means of a blade coater at a gap height of 6 mm and dried at 120° C. for 20 minutes.

Fresh white foams having good mechanical properties were obtained without exception. As is discernible from Table 1, using the specific (foam) additives 2, 5, 6, 10 and 12 resulted in foams being obtained which combined a high imbibition rate with regard to physiological saline and good free swell absorptive capacity with a fine, homogeneous pored structure.

By way of example, foam S5 was tested according to ISO 10993.5 and found to be non-cytotoxic.

TABLE 1

| | | Amount [g] | Imbibition | | Porosity/ |
|---|---|---|---|---|---|
| | Example | (content | rate¹⁾ | Free swell²⁾ | foam |
| Foam | # | [%]) | [s] | [g/100 cm²] | structure |
| S1 | 2 | 25.3 (15) | 48 | not | very fine |
| | | | | determined | |
| S2 | 5 | 12.6 (30) | 4 | 30 | very fine |
| S3 | 6 | 12.4 (30) | 15 | 56 | medium |
| S4 | 10 | 13.2 (28) | 28 | 46 | fine |
| S5 | 12 | 11.8 (25) | 44 | 47 | very fine |

¹⁾Time for complete penetration of one millilitre of test solution A prepared as in DIN EN 13726-1 Part 3.2; test on side facing the paper;
²⁾Free swell absorptive capacity was determined to DIN EN 13726-1 Part 3.2.

### Comparative Examples V1-V2

### Production of Foams from Polyurethane Dispersion 1 and a Surfactant

As indicated in Table 2, 120 g, for each example, of polyurethane dispersion 1, prepared according to Example 1, were mixed with various (foam) additives and frothed by means of a commercially available hand stirrer (stirrer made of bent wire) to a 0.5 litre foam volume. Thereafter, the foams were drawn down on non-stick paper by means of a blade coater at a gap height of 6 mm and dried at 120° C. for 20 minutes.

As is discernible from Table 2, the foams V1 and V2 have an additive-caused, strongly cytotoxic effect when tested to ISO 10993.5: cell viabilities were below 3% with these foams.

TABLE 2

| | (Foam) additives | | | | Porosity/ | |
|---|---|---|---|---|---|---|
| | | Amount | | Amount | foam | |
| Foam | Type¹⁾ | [g] | Type¹⁾ | [g] | structure | Cytotoxicity²⁾ |
| V1 | A | 4.34 | B | 5.76 | very fine | strongly |
| | | | | | | cytotoxic |
| V2 | A | 0.24 | C | 1.47 | fine, but | strongly |
| | | | | | graining & | cytotoxic |
| | | | | | volume | |
| | | | | | shrinkage | |

¹⁾A: ammonium stearate (ca. 30%, Stokal ® STA, Bozzetto GmbH, Krefeld, DE); B: sulphosuccinamate (ca. 34%, Stokal ® SR, Bozzetto GmbH, Krefeld, DE); C: C12-C16 fatty alcohol polyglycoside (ca. 51%, PlantaCare ® 1200 UP, Cognis Deutschland GmbH & Co. KG, Düsseldorf, DE);
²⁾Tested to ISO 10993.5

1.-13. (canceled)

14. A composition obtained by mixing at least polyurethanes (I) having a free isocyanate group content of not more than 1.0% by weight and a 10% to 95% by weight content of ethylene oxide units incorporated via monofunctional alcohols B) and arranged within polyether chains, wherein the polyurethanes (I) have been prepared by reaction of
A) polyisocyanate prepolymers having an (average) NCO functionality of greater than or equal to 1 with
B) 10 to 100 equivalent %, based on the isocyanate groups of A), of a monohydric alcohol component comprising at least one monohydric polyether alcohol having a number average molecular weight in the range of from 150 to 5000 g/mol and having a content of oxyethylene units of from 30 to 100 mol %, based on the total content of oxyalkylene units in the monohydric polyether alcohol,
C) 0 to 20 equivalent %, based on the isocyanate groups of A), of a monohydric alcohol component comprising monohydric alcohols having a number average molecular weight in the range from 32 to 5000 g/mol which are in addition to the compounds of component B),
D) 0 to 80 equivalent %, based on the isocyanate groups of A), of constructional components having a number average molecular weight in the range of from 32 to 10,000 g/mol which are at least difunctional
with urethane formation and with or without urea formation, wherein any excess NCO groups have been reacted away, by simultaneous or subsequent secondary reactions, down to a residual content of less than or equal to 1.0% by weight,
and foamable polymers (II) which are based on polymers selected from the group consisting of polyureas, polyurethanes, polyurethane polyacrylates, polyurethane polyesters, polyurethane polyethers, polyurethane polyureas, polyurethane polycarbonates, and mixtures thereof in the form of their aqueous dispersions.

15. The composition according to claim 14, wherein the polyurethanes (I) comprise a content of ethylene oxide units of from 45% to 55% by weight, based on the polyurethane.

16. The composition according to claim 14, wherein the polyisocyanate prepolymers of component A) have an average NCO functionality of from 1.8 to 2.2.

17. The composition according to claim 14, wherein the polyisocyanate prepolymers of component A) are prepared using polyols having OH functionalities of from 1.8 to 2.5.

18. The composition according to claim 17, wherein the polyols comprise polyether polyols having number average molecular weights of from 300 to 8000 g/mol.

19. The composition according to claim 18, wherein the polyether polyols have a polydispersity of from 1.0 to 1.5 and an OH functionality of greater than 1.9 and an unsaturated end group content of less than or equal to 0.02 milliequivalents per gram of polyol, as determined by ASTM D2849-69.

20. The composition according to claim 18, wherein the polyurethanes (1) of component B) are prepared using monohydroxyl-functional polyalkylene oxide polyether alcohols which on average comprises from 5 to 70 ethylene oxide units per molecule and 30 to 100 mol % of ethylene oxide units and 0 to 70 mol % of propylene oxide units based on the total amount of oxyalkylene units.

21. The composition according to claim 14, wherein the foamable polymers (II) comprise anionically hydrophilicized polyurethanes in the form of aqueous dispersions.

22. The composition according to claim 21, wherein the anionically hydrophilicized polyurethanes in the form of aqueous dispersions are obtained by
E) providing isocyanate-functional prepolymers obtained from at least
E1) organic polyisocyanates,
E2) polymeric polyols having number average molecular weights of from 400 to 8000 g/mol and OH functionalities of from 1.5 to 6, and
E3) optionally, hydroxyl-functional compounds having molecular weights of from 62 to 399 g/mol, and
E4) optionally, isocyanate-reactive, anionic or potentially anionic hydrophilicizing agents and/or optionally non-ionic hydrophilicizing agents,
F) wholly or partly reacting by chain extension the free NCO groups of the isocyanate-functional prepolymers with
F1) optionally amino-functional compounds having molecular weights of from 32 to 400 g/mol and/or
F2) isocyanate-reactive, anionic or potentially anionic hydrophilicizing agents
wherein the prepolymers being dispersed in water before, during or after step F), any potentially ionic groups present being converted into the ionic form by partial or complete reaction with a neutralizing agent.

23. The composition according to claim 22, wherein the isocyanate-reactive, anion or potentially anionic hydrophilicizing agent is amino-functional.

24. A process for producing polymer foams comprising frothing and drying the composition according to claim 14.

25. A foam obtained by the process according to claim 24.

26. A wound contact material comprising the foam according to claim 25.

27. A wound contact material obtained from the composition according to claim 14.

28. A process which comprises mixing at least polyurethanes (I) having a free isocyanate group content of not more than 1.0% by weight and a 10% to 95% by weight content of ethylene oxide units incorporated via monofunctional alcohols B) and arranged within polyether chains, wherein the polyurethanes (I) have been prepared by reaction of
A) polyisocyanate prepolymers having an (average) NCO functionality of greater than or equal to 1 with
B) 10 to 100 equivalent %, based on the isocyanate groups of A), of a monohydric alcohol component comprising at least one monohydric polyether alcohol having a number average molecular weight in the range of from 150 to 5000 g/mol and having a content of oxyethylene units of from 30 to 100 mol %, based on the total content of oxyalkylene units in the monohydric polyether alcohol,
C) 0 to 20 equivalent %, based on the isocyanate groups of A), of a monohydric alcohol component comprising monohydric alcohols having a number average molecular weight in the range from 32 to 5000 g/mol which are in addition to the compounds of component B),
D) 0 to 80 equivalent %, based on the isocyanate groups of A), of constructional components having a number average molecular weight in the range of from 32 to 10,000 g/mol which are at least difunctional
with urethane formation and with or without urea formation, wherein any excess NCO groups have been reacted away, by simultaneous or subsequent secondary reactions, down to a residual content of less than or equal to 1.0% by weight,
and foamable polymers (II) which are based on polymers selected from the group consisting of polyureas, polyurethanes, polyurethane polyacrylates, polyurethane polyesters, polyurethane polyethers, polyurethane polyureas, polyurethane polycarbonates, and mixtures thereof in the form of their aqueous dispersions.

29. The process as claimed in claim 28 further comprising frothing and drying the mixture of polyurethanes (I) and foamable polymers (II).
